(19) United States
(12) Patent Application Publication
(10) Pub. No.: US 2002/0051453 A1
(43) Pub. Date: May 2, 2002

(54) Apparatus and method for restoring cell sequence in multipath ATM switches

(76) Inventors: Jeong Won Heo, Incheon (KR); Seon Hoon Lee, Incheon (KR); Jong Kun Lee, Incheon (KR); Dan Keun Sung, Incheon (KR)

Correspondence Address: Richard E. Fichter, BACON & THOMAS, PLLC, Fourth Floor, 625 Slaters Lane, Alexandria, VA, 22314-1176, US

(21) Appl. No.: 09/988,126

(22) Filed: Nov. 19, 2001

Related U.S. Application Data
(63) Continuation of application No. PCT/KROO/00494, filed on May 19, 2000.

(30) Foreign Application Priority Data
May 19, 1999 (KR) 1999-17947

(51) Int. Cl. H04L 12/56

(52) U.S. Cl. 370/394; 370/399; 370/412

(57) ABSTRACT

A cell re-sequencer restores cell sequence in multipath ATM switches by using per-VC logical queues that store only cells belonging to a same VC. The re-sequencer can reduce processing time to a shorter value than those of conventional re-sequencer mechanisms. Also, this re-sequencer has no restriction on the peak rate of VCs and no arbitration functions to select an output cell. The re-sequencer comprises a RAM buffer, a CAM/RAM table, a controller, etc.

This application is a Continuation Application of PCT International Application No. PCT/KR00/00494 filed on May 19, 2000, which designated the United States.

### FIELD OF THE INVENTION

The present invention relates to an apparatus and method for restoring cell sequence in asynchronous transfer mode (ATM) switches; and more particularly, to an apparatus and method for restoring cell sequence in the multipath ATM switches by using per-VC (virtual channel) logical queues that store only the cells belonging to a same VC to thereby reduce its processing time.

### DESCRIPTION OF THE PRIOR ART

Multipath ATM switches are used to construct large switches from switch modules. These switches have two advantages: 1) traffic distribution can be maintained more uniformly throughout the switches to minimize internal contentions, and 2) the switches are more fault-tolerant. However, since multiple paths are available between every input and output pair of the switches, optimal path allocation is required.

Input cells from an input port may be out of sequence at a corresponding output port because multiple switching paths do not have a same transfer delay. Therefore, in order to restore a proper cell sequence, a re-sequence mechanism must be added to multipath switch systems. Systems using multipath networks with the re-sequence mechanism have been proposed by Turner et al. (see, Jonathan Turner and Naoaki Yamanaka, “Architecture choices in large scale ATM switches”, IEICE Trans. Commun., vol. E81-B, no. 2, pp. 120-137, Feb. 1998), Henrion et al. (see, M. A. Henrion, G. J. Eilenberger, G. H. Petit, and P. H. Parmentier, “A multipath self-routing switch”, IEEE Commun. Mag., vol. 31, no. 4, pp. 46-52, April 1993), Collivignarelli et al. (see, M. Collivignarelli, A. Daniele, P. De Nicola, L. Licciardi, M. Turolla, and A. Zappalorto, “A complete set of VLSI circuits for ATM switching”, in Proc. IEEE Globecom., pp. 134-138, 1994), Aramaki et al. (see, T. Aramaki, H. Suzuki, S. Hayano, and T. Takeuchi, “Parallel “ATOM” switch architecture for high-speed ATM networks”, in Proc. IEEE ICC, pp. 250-254, 1992), and Jung et al. (see, Youn C. Jung and Chong K. Un, “Banyan multipath self-routing ATM switches with shared buffer type switch elements”, IEEE Trans. Commun., vol. 43, no. 11, pp. 2847-2857, Nov. 1995).

Thus, there have been two cell re-sequence approaches. These are a timing based approach proposed by Turner et al., Henrion et al., Collivignarelli et al. and Aramaki et al. supra, and a preventive approach proposed by Jung et al. supra.

In the timing based approach, a re-sequencer located at each output port of a switch restores the proper cell sequence by using time stamps which are generated at an input interface. These time stamps are written on tags of input cells. In general, the re-sequencer using time stamps requires a re-sequence buffer. Specifically, Turner et al. proposed a cell re-sequencer based on the age of cells computed from the time of entry at an input interface to the current time. However, since all ages of buffered cells have to be examined for selection of an oldest cell through an output process, the re-sequencer requires a long processing time. Further, the re-sequencer requires an arbitration function to choose one among cells having a same age. Meanwhile, Henrion et al. proposed a cell re-sequence mechanism based on the principle of delay equalization on a cell basis. The variable delay experienced by a cell through the switch fabric is complemented by a re-sequence delay in a re-sequence buffer before the cell is released to an output interface. In this case, all the time stamp values of buffered cells for re-sequence have to be searched in order to check their delays and, thus, this search needs a complicated buffer management. This re-sequencer also requires an arbitration function to choose one among the cells with the same compensation delay.

A parallel ATOM switch includes a re-sequencer that searches only cells stored at the head of buffer memories in switch planes. However, the re-sequencer is applicable only to multipath switches with parallel planes, and these switches require a large size of memory because of no sharing effect thereof. Therefore, the re-sequencer cannot be used in multi-stage multipath switches.

In the preventive approach, a spacing controller located at each entry of a switch provides a predetermined minimum spacing between two adjacent cells of a same VC. However, this approach is inapplicable to VCs with high peak rates because the cell interarrival times of VCs may be much smaller than the minimum spacing and, thus, a quality-of-service (QoS) of the VC can be degraded. And cells of the delay buffer in the spacing controller have to be examined in order to ensure the required minimum spacing between two adjacent cells of the same VC.

### SUMMARY OF THE INVENTION

It is, therefore, an object of the present invention to provide a new cell re-sequence apparatus and method with fast control functions to thereby reduce the number of time stamp comparisons and the required processing time, wherein, since the inventive apparatus and method is a timing based scheme using time stamps, it is applicable to VCs with any peak rate and the present invention uses per-VC logical queues that store only the cells belonging to a same VC. That is, only the cells in a same logical queue are considered for maintenance of the cell sequence of the corresponding VC.

In accordance with one aspect of the present invention, there is provided an apparatus for restoring cell sequence in a switch fabric, which comprises:

an input cell register for temporarily storing an input cell;

a shift register for storing VCI values for a plurality of cells including the input cell provided from the input cell register and outputting each of the VCI values after a predetermined cell time; and

logical queues for sorting the cells based on their VCI and time stamp values to thereby place each of the cells at a proper position in a corresponding logical queue, and outputting said each of the cells in response to the outputted VCI value, wherein cells having a same VCI value are arranged in one corresponding logical queue according to the order of their time stamp values.

In accordance with another aspect of the invention, there is provided a method for restoring cell sequence in a switch fabric, which comprises the steps of:

(a) examining a virtual channel identifier (VCI) value of an input cell and transmitting the input cell to a logical queue that has a same VCI as that of the input cell;

(b) placing the input cell at a proper position in the logical queue by comparing a time stamp value of the input cell with those of cells stored in the logical queue;

(c) repeating the steps (a) and (b) for a plurality of input cells;

(d) selecting a head cell among the cells stored in the logical queue by using the VCI value of the input cell as an index after a predetermined cell time;

(e) outputting the head cell as an output cell; and

(f) repeating the steps (d) and (e) for the remaining cells among the input cells.

### BRIEF DESCRIPTION OF THE DRAWINGS

The above and other objects and features of the present invention will become apparent from the following description of the preferred embodiment given in conjunction with the accompanying drawings, in which:

FIG. 1 represents a cell re-sequence mechanism in accordance with the present invention;

FIG. 2 exemplifies a structure of a re-sequencer in accordance with a preferred embodiment of the present invention;

FIGS. 3A and 3B show data updates of a CAM/RAM table and a RAM buffer described in FIG. 2;

FIGS. 4A and 4B illustrate a process of recombining a linked list by comparison of cell time stamps in a logical queue;

FIGS. 5A and 5B depict an example of an output process in accordance with the present invention; and

FIGS. 6A and 6B describe the performance of the re-sequence mechanism in accordance with the present invention.

### DETAILED DESCRIPTION OF THE PREFERRED EMBODIMENT

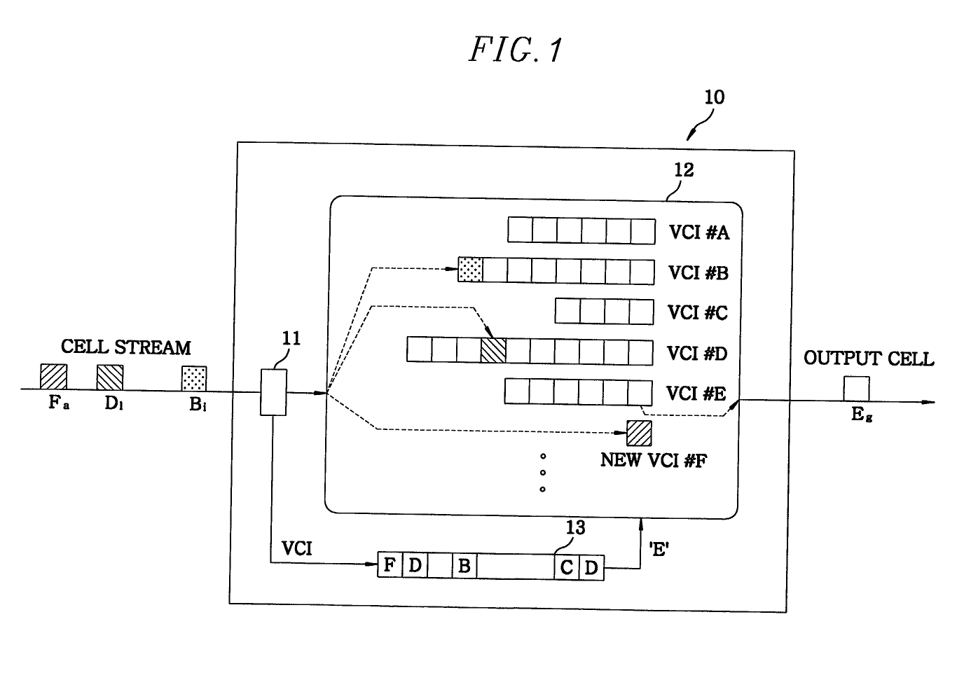

The preferred embodiments of the present invention will now be described with reference to FIGS. 1 to 6B.

FIG. 1 describes a cell re-sequence mechanism in accordance with the present invention.

In this mechanism, a re-sequencer 10 is connected to each output port of a switch fabric. The re-sequencer 10 comprises an input cell register (ICR) 11, per-VC logical queues 12 and a VCI (virtual channel identifier) shift register (VSR) 13.

Cells with a same VCI are temporarily stored in the input cell register 11 to be sorted and then arranged in a corresponding logical queue according to the order of time stamp values thereof, wherein each input cell is fed to a logical queue corresponding to its VCI value.

When cells arriving at the output port of the switch fabric are provided to the re-sequencer 10, they are stored in the corresponding per-VC logical queues 12 and their VCI values are sent to the VSR 13. For example, an input cell Bᵢ corresponds to an i-th arriving cell that has a VCI value of B, and this cell is sent to a logical queue #B in order to maintain cell sequence integrity.

The input process at the re-sequencer 10 is as follows. First, once an input cell is provided thereto, the re-sequencer 10 first examines the VCI of the input cell. If there is a logical queue that has a same VCI as that of the input cell among the per-VC logical queues 12, then the input cell is transmitted to the corresponding logical queue. The input cell is then placed at a proper position in the logical queue by comparison of the time stamp value of the input cell with the time stamp values of cells in the corresponding logical queue. If there is no logical queue with the VCI value of the input cell, then a new logical queue with the VCI value of the input cell is generated and the input cell is stored in the new logical queue. Since the comparisons in this input process are performed only among the cells belonging to the same VC, it can reduce the number of time stamp comparisons.

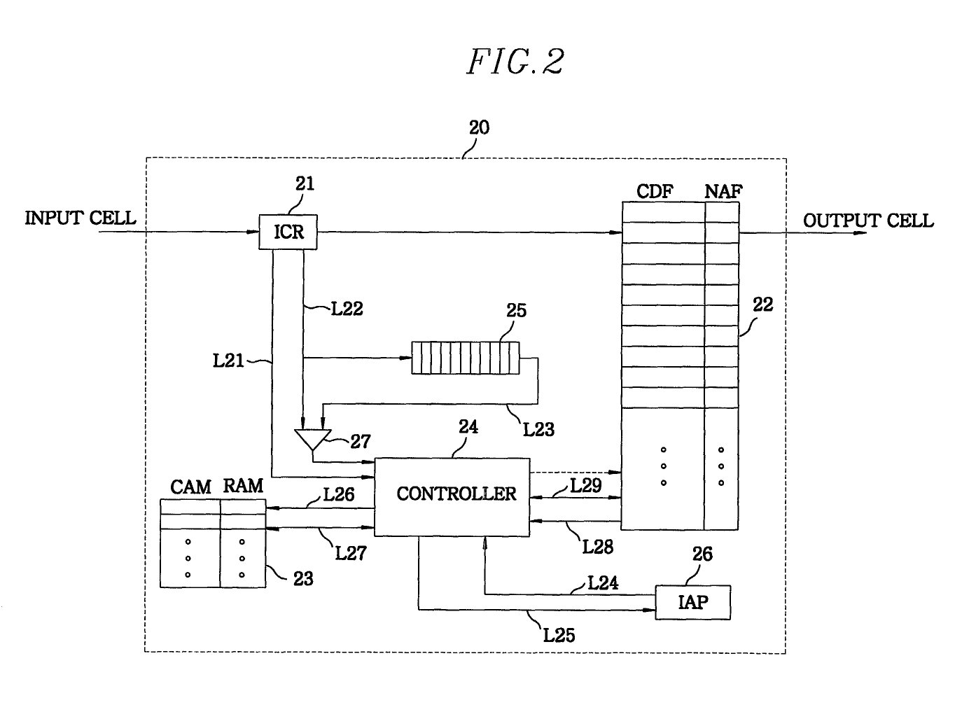

The output process of the re-sequencer 10 is simple. Since the VSR 13 is a shift register with a depth of V, the VCI value is shifted out of the VSR 13 after V cell times from the instant of entry to the VSR 13, wherein V is a difference between the minimum and maximum permissible transfer delay within the switch fabric. A head cell of the corresponding logical queue is selected for transmission by using its VCI value as an index. The above mechanism can be implemented through the use of a linked-list method as shown in FIG. 2.

Referring to FIG. 2, there is illustrated a structure of a re-sequencer 20 in accordance with a preferred embodiment of the present invention.

The re-sequencer 20 comprises an ICR 21, a RAM buffer 22, a content addressable memory/random access memory (CAM/RAM) table 23, a controller 24, a VSR 25, an idle address pool (IAP) 26 and a selector 27.

The ICR 21 temporarily stores an input cell during an input queuing process.

The input cell is stored in the RAM buffer 22 until the cell is extracted out of the re-sequencer 20.

The CAM/RAM table 23 contains a VCI value of each per-VC logical queue and a RAM buffer address of a first cell in each logical queue.

The controller 24 manages input and output processes of the RAM buffer 22 and compares a time stamp value of the input cell provided from the ICR 21 via a line L21 with those of cells stored in the RAM buffer 22 provided via a line L28. The controller 24 simply includes some combinatorial logic and flip-flops.

The VSR 25 receives the VCI value of the input cell from the ICR 21 via a line L22 and shifts it out to the controller 24 via a line L23 for the output queuing process.

The IAP 26 provides an idle address of the RAM buffer 22 to the controller 24 via a line L24 upon arrival of a new input cell.

The selector 27 provides the controller 24 with the VCI value of each per-VC logical queue from the ICR 21 during the input queuing process. On the other hand, the selector 27 supplies the VCI value outputted from the VSR 25 to the controller 24 during the output queuing process.

The re-sequencer 20 is logically organized as linked lists, one for each per-VC logical queue. A linked list is a set of chained buffer locations occupied by successive cells of a particular VC. The linked list is implemented by using the RAM buffer 22 and the CAM/RAM table 23.

In the CAM/RAM table 23, a CAM part contains the VCI value of each per-VC logical queue provided from the controller 24 via a line L26, while a RAM part stores a RAM buffer address indicating a position of a head cell provided from the controller 24 via a line L27 in each logical queue.

The RAM buffer 22 includes a cell data field (CDF) storing cells and time stamp values, and a next address field (NAF) storing the addresses of successive cells in the logical queue. Thus, the linked list is constructed by using the address of a head cell, which is stored in the RAM part of the CAM/RAM table 23, and the addresses of successive cells, which are stored in the NAF of the RAM buffer 22.

The input process of the re-sequencer 20 is as follows. When the re-sequencer 20 receives an input cell from the output port of the switch fabric, the input cell is temporarily stored in the ICR 21 and its VCI and time stamp values are delivered to the controller 24 via lines L21 and L22, respectively. The controller 24 examines whether a same VCI value as that of the input cell exists in the CAM part of the CAM/RAM table 23.

In the first case that the CAM part does not contain the same VCI index as the input cell, the controller 24 registers a new VCI value in the CAM part and writes a RAM buffer address of the head cell, i.e., the input cell, on the RAM part of the CAM/RAM table 23. The RAM buffer address is here provided by the IAP 26 via a line L25, which maintains the idle addresses of the RAM buffer 22. Finally, the input cell and its time stamp value are transferred from the ICR 21 to the CDF of the addressed position in the RAM buffer 22, and an end of logical queue (EOL) mark is written on the NAF.

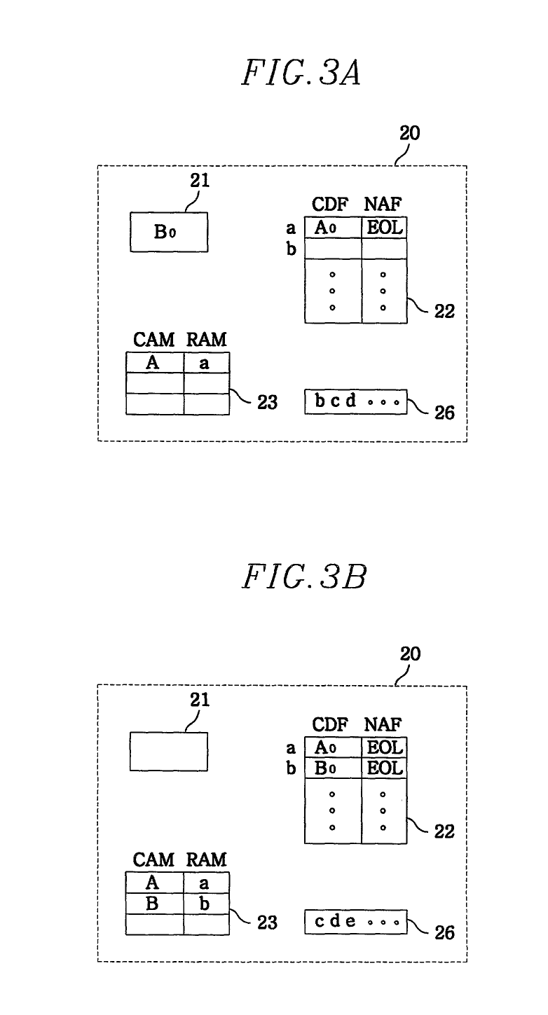

For instance, FIGS. 3A and 3B show data updates of the CAM/RAM table 23 and the RAM buffer 22 when an input cell Bo has a VCI value of B, which has not existed yet in the CAM/RAM table 23. When the input cell Bo having a new VCI value of B is fed to the ICR 21, the new VCI value of B is registered on the CAM part and the address of a head cell, b, given from the IAP 26 is sent to the RAM part of the CAM/RAM table 23 as shown in FIG. 3B. The cell B₀ and EOL mark are written on the RAM buffer 22.

In the second case that the CAM part of the CAM/RAM table 23 contains the same VCI index as the input cell, the address of the head cell of the VCI index is delivered to the controller 24 via the line L27. Using this address, the controller 24 reads the time stamp value of the head cell from the CDF via the line L28, and the address of the subsequent cell from the NAF via the line L29. The controller 24 compares the time stamp value of the input cell with that of the head cell. If the input cell is younger than the head cell, the controller 24 reads the time stamp and NAF values of the subsequent cell. Comparisons of the time stamp of the input cell with those of the cells stored in the RAM buffer 22 are repeated until the controller 24 finds a proper position for the input cell. Since the cell sequence of the corresponding logical queue has been sorted before the arrival of the input cell, it is sufficient to find only the first cell with a time stamp value that post-dates the time value of the input cell in the corresponding linked-list for the purpose of searching the proper position. Then, the input cell is inserted just before the first cell in the linked-list logical queue. Otherwise, the input cell is attached to the end of the corresponding linked-list.

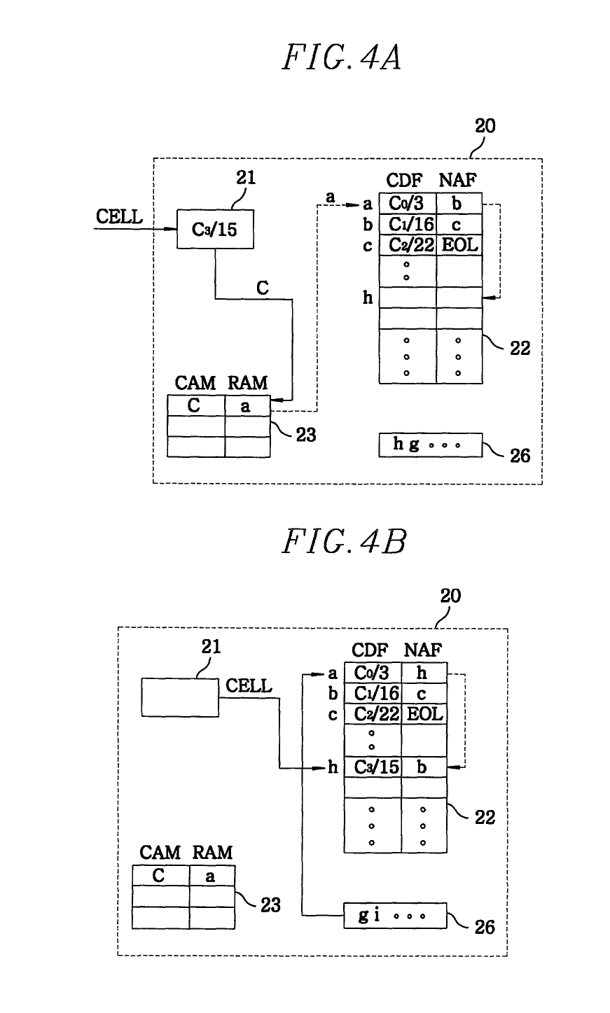

For re-sequence of cells in the logical queue, the controller 24 recombines the linked list by comparison of the cell time stamps as shown in FIGS. 4A and 4B.

In FIG. 4A, an input cell C₃/15 is transmitted to the ICR 21, where the VCI value and the time stamp value of C₃ are C and 15, respectively. Since the CAM/RAM table 23 has a VCI index of C, the controller 24 can receive the address of a head cell C₀, which is named ‘a’, from the RAM part of the CAM/RAM table 23. The subsequent cells, C₁ and C₂, are connected to the head cell through the use of a linked list. The controller 24 compares the time stamp values until finding the first out-of-sequence cell or the end of the logical queue. Since the first out-of-sequence cell is C₁/16 as shown in the example of FIG. 4A, the controller 24 inserts the input cell C₃ just before C₁. Thus, the sequence of the linked list for the VCI index of C is changed from C₀-C₁-C₂ to C₀-C₃-C₁-C₂. As a result, as shown in FIG. 4B, the NAF value of the RAM buffer 22 with the address of ‘a’ is changed from ‘b’ to ‘h’ and the NAF value of the RAM buffer 22 with an address of ‘h’ is changed to ‘b’.

The output process of the re-sequencer 20 is much simpler than the input process described above. When the VCI value of an input cell is sent from the ICR 21 to the controller 24, the VCI value is also transmitted to the VSR 25. The size of the VSR 25, V, is a difference between the minimum and maximum permissible transfer delay in the switch fabric. After V cell times, the VCI value is shifted out from the VSR 25 and is sent to the controller 24 for the output process. Using the VCI value, the controller 24 receives an address of a head cell from the CAM/RAM table 23 and outputs the head cell pointed by the address. The address of the output cell is transmitted to the IAP 26 and the NAF value of the cell is written on the RAM part of the CAM/RAM table 23. If the NAF value is an EOL mark, the VCI index is deleted from the CAM/RAM table 23 instead of writing an NAF value on the RAM part.

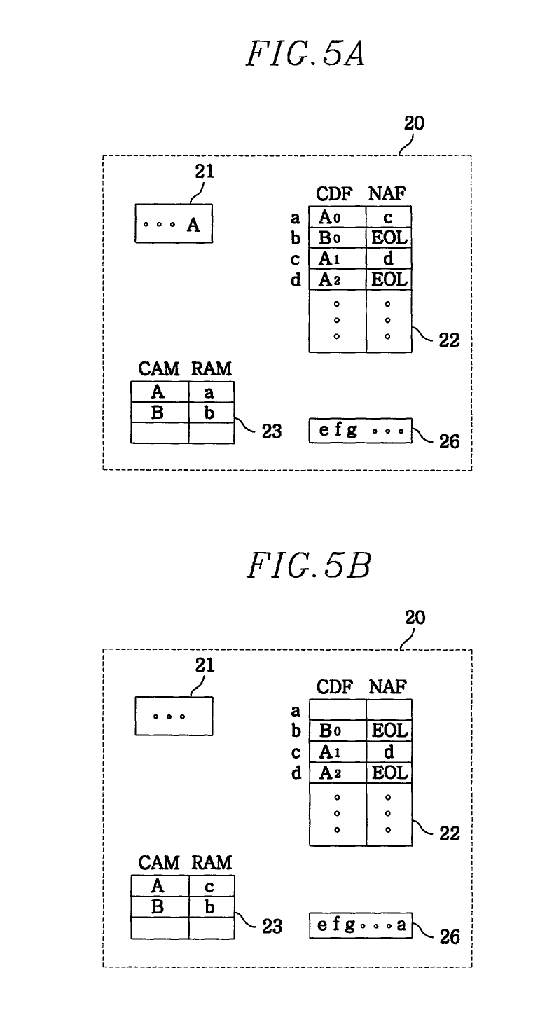

Referring to FIGS. 5A and 5B, there is shown an example of the output process.

In FIG. 5A, an output VCI value, e.g., A, is shifted out from the VSR 25. Using the VCI value, the address of a head cell, ‘a’, is read from the CAM/RAM table 23. The head cell is extracted from the RAM buffer 22 and its address is sent to the IAP 26 for later cell storage. In this case, since the NAF value of the cell is not an EOL mark, it is written on the corresponding RAM part of the CAM/RAM table 23 as shown in FIG. 5B. The output processes for the other cells stored in the RAM buffer 22 also follow this process.

In accordance with another preferred embodiment of the present invention, in order to implement a faster re-sequencer, a RAM buffer can be divided into two parts, e.g., a cell data field and a time stamp/NAF field. The cell data field stores input cells and extracts cells under the control of a controller and the time stamp/NAF field stores the time stamp values and the NAF values of input cells for re-sequence of cells. Since the function of each field is quite different, the RAM buffer can be easily split into these two fields. While the cell stored in the cell data field is transmitted to the output of the re-sequencer, the time stamp value of a new input cell can be compared with those stored in the time stamp/NAF field. A proper position of the new input cell in a corresponding logical queue can be found simultaneously with an egressing process. Thus, this method increases the operation speed of the proposed re-sequencer.

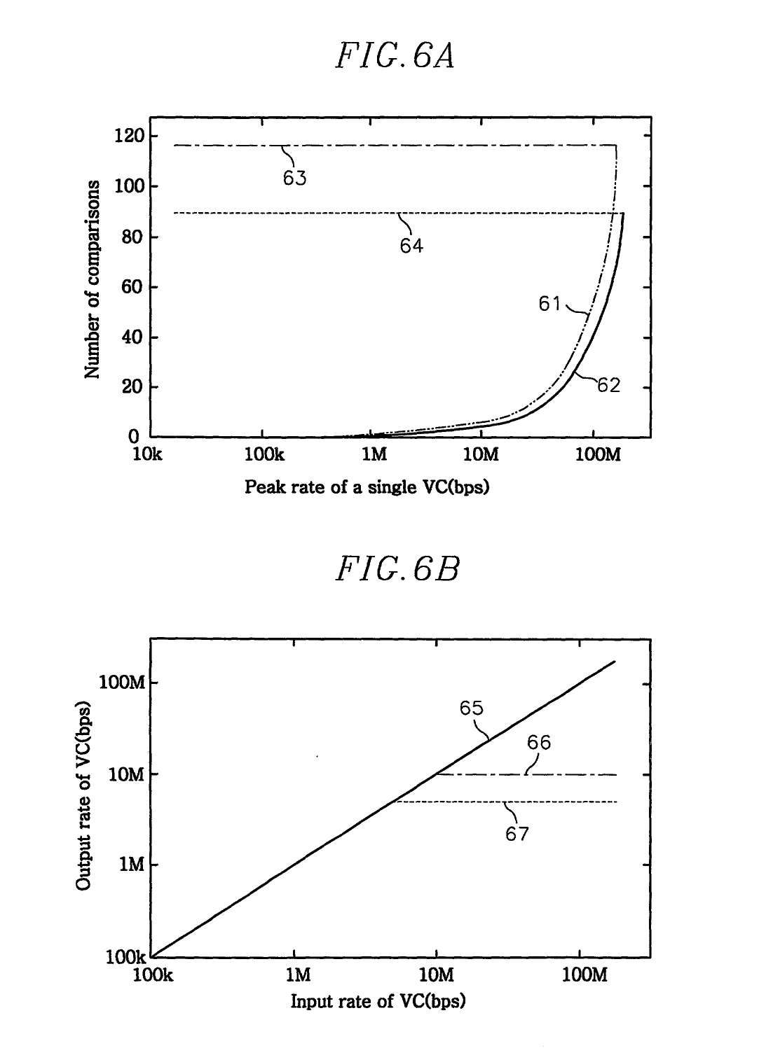

Referring to FIGS. 6A and 6B, there are described the performance of the re-sequence mechanism in accordance with the present invention.

The performance of the re-sequence mechanism is evaluated from two points of view: the number of comparisons for processing one cell and the permissible peak rate of a VC.

First, the performance of the inventive scheme is compared with conventional timing based schemes in terms of the number of comparisons. The inventive mechanism can reduce the required processing time to a shorter value than those of the conventional schemes through the use of a re-sequence buffer because in the inventive scheme, only cells with the same VCI value are to be considered for reordering the cell sequence instead of processing the time stamps of all cells stored in the re-sequence buffer.

$${R}_{peak}^{X}$$

is defined as a peak rate of a single VC with a VCI value of X, and N^{X} is defined as the upper bound number of time stamp comparisons for the VC. N^{X} is given as follows:

$${N}^{X} = \frac{{R}_{peak}^{X}}{C} \times B \times ρ ,$$

wherein C is a bandwidth of an input/output link, B(V≦B) is a size of the re-sequence buffer, and ρ is an output traffic load of a multipath switch. On the other hand, Turner's and Henrion's schemes require comparisons B×ρ times for selection of an output cell irrespective of

$${R}_{peak}^{X} .$$

If a single VC with a VCI value of X has a peak rate of

$$C ( {R}_{peak}^{X} = C ) ,$$

N^{X} of the inventive scheme is given as follows:

$${N}^{X} = \frac{{R}_{peak}^{X}}{C} \times B \times ρ = B \times ρ ,$$

In this case, the number of comparisons is the same value as that of the conventional schemes. But, in real ATM environments, the whole link capacity (e.g., 155 Mbps or 622 Mbps) is generally occupied by multiple VCs rather than by a single VC. And if a single VC with a VCI value of Y is peak-rate limited to P<C, the number of comparisons is given as follows:

$${N}^{Y} = \frac{{R}_{peak}^{Y}}{C} \times B \times ρ = \frac{P}{C} \times B \times ρ ,$$

FIG. 6A shows a plot of N^{X} versus

$${R}_{peak}^{X}$$

under the assumption that all schemes have a same size of B. For example, if B=128,

$${R}_{peak}^{X} = 5 Mbps ,$$

C=155 Mbps and ρ=0.9, then N^{X} is approximately equal to 3.7, which is very small compared to B×ρ=115.2, which corresponds to the number of comparisons required in the conventional schemes. In particular, the cells belonging to VCs with lower rates experience a smaller number of comparisons because the re-sequencer may have no other cells belonging to the same VC in the re-sequence buffer. For instance, for a VC with 64 kbps the probability that the re-sequence buffer includes some cells of a same VC is negligibly low. More specifically, FIG. 6A illustrates the experimental results of the inventive scheme, 61 and 62, and the Turner's and Henrion's scheme, 63 and 64, for two cases, ρ=0.9 and ρ=0.7, respectively.

Second, the performance of the inventive scheme is compared with the preventive scheme in view of limitation on the rate of a VC. Since the inventive scheme is a timing based scheme using time stamps, it is applicable to VCs with any peak rates. Thus, in the inventive scheme, the maximum allowable output rate

$${R}_{0}^{max}$$

is equal to C. On the other hand, the preventive scheme may have performance degradation for VCs with high peak rates because cell intervals of the high peak rate VCs can be much smaller than the minimum spacing. In the preventive scheme,

$${R}_{0}^{max}$$

is given as follows:

$${R}_{0}^{max} = \frac{C}{{T}_{min}} ,$$

wherein Tₘᵢₙ is the minimum spacing between two adjacent cells.

FIG. 6B shows a plot of the output rate versus the input rate of a VC for the inventive scheme, 65, and the preventive scheme, 66 and 67, with two cases of minimum spacing, 16 and 32. If the minimum spacing is equal to 32, then the QoS of the VCs, which have peak rates larger than 4.8 Mbps, can be degraded. Thus, the inventive scheme is applicable to the multipath switching system with bursty high peak rate input traffic.

As illustrated above, the above re-sequencer in accordance with the present invention has the following advantages. First, the re-sequencer can be used irrespective of the peak rates of VCs because the re-sequencer is not a preventive approach using predetermined minimum spacing. Second, the re-sequencer can reduce a processing time to a much shorter value than those of the conventional timing based approaches because only the cells in the same logical queue are to be considered for reordering of the cell sequence of the corresponding VC. Except for storing a new input cell and its NAF, only one update in the NAF value of the RAM buffer is needed in order to re-sequence cells. Third, the re-sequencer does not need any arbitration functions for output cell transmission. Since the VSR provides one VCI value for the output process, there is no contention between cells in the re-sequencer. Finally, the inventive scheme needs a small size of RAM buffer. Since all per-VC logical queues are shared in one RAM buffer, this sharing effect reduces the required size of the RAM buffer. The CAM/RAM table does not require a large size of memory because the length of one VCI or one address is much smaller than that of one cell, i.e., 424 bits.

While the present invention has been described with respect to certain preferred embodiments only, other modifications and variations may be made without departing from the spirit and scope of the present invention as set forth in the following claims.

What is claimed is:

1. An apparatus for restoring cell sequence in a switch fabric, which comprises:
a first registering means for temporarily storing an input cell;
a second registering means for storing virtual channel identifier (VCI) values for a plurality of cells including the input cell provided from the first registering means and outputting each of the VCI values after a predetermined cell time; and
logical queuing means for sorting the cells based on their VCI and time stamp values to thereby place each of the cells at a proper position in a corresponding logical queue, and outputting said each of the cells in response to the outputted VCI value, wherein cells having a same VCI value are arranged in one corresponding logical queue according to the order of their time stamp values.

2. The apparatus as recited in claim 1, wherein the logical queuing means includes:
a buffering means for storing the cells in corresponding logical queues until the cells are outputted;
a storage means for containing a VCI value corresponding to said each of the logical queues and a buffer address representing a position of a head cell in said each of the logical queues; and
a controlling means for managing an input and output process of the buffering means based on the VCI and time stamp values of the cells.

3. The apparatus as recited in claim 2, wherein the logical queuing means further includes an idle address providing means for supplying an idle address of the buffering means to the controlling means upon arrival of the input cell, wherein an address of an outputted cell is transmitted to the idle address providing means and treated as the idle address.

4. The apparatus as recited in claim 2, wherein the storage means contains:
a content addressable memory (CAM) for storing the VCI value corresponding to said each of the logical queues; and
a random access memory (RAM) for storing the buffer address representing the position of the head cell in said each of the logical queues.

5. The apparatus as recited in claim 4, wherein the buffering means contains:
a cell data field (CDF) for storing the cells and the time stamp values of the cells; and
a next address field (NAF) for storing addresses of successive cells in said each of the logical queues.

6. The apparatus as recited in claim 5, wherein, if the input cell is provided, the controlling means performs the input process of the buffering means through the steps of:
(a1) examining whether the same VCI value as that of the input cell exists in the CAM part of the memory table;
(a2) if the storage means contains no VCI value corresponding to the input cell, registering a new VCI value in the CAM part and writing a new buffer address of the input cell on the RAM part of the storage means, wherein the input cell is treated as a head cell of a new logical queue corresponding to the new VCI value; and
(a3) if the CAM part of the storage means contains the same VCI value as that of the input cell, receiving the buffer address of the head cell of the logical queue corresponding to the VCI value of the input cell, reading a time stamp value of the head cell from the CDF by using the buffer address of the head cell and the address of the subsequent cell from the NAF, and finding the proper position of the input cell to thereby place the input cell at the proper position by comparing the time stamp value of the input cell with those of the cells stored in the buffering means.

7. The apparatus as recited in claim 6, wherein, if the storage means contains no VCI value corresponding to the input cell, the input cell and its time stamp value are transferred from the first registering means to the CDF of the addressed position in response to said new buffer address and an end of logical queue (EOL) mark is written on the NAF.

8. The apparatus as recited in claim 7, wherein the controlling means performs the output process of the buffering means through the steps of:
(b1) receiving a VCI value shifted out from the second registering means;
(b2) receiving an address of a head cell of a logical queue corresponding to said VCI value from the storage means; and
(b3) outputting said head cell pointed by the address and designating a subsequent cell of said head cell as a new head cell in the logical queue.

9. The apparatus as recited in claim 4, wherein the buffering means contains:
a first field for storing the cells and extracting the cells by the controlling means; and
a second field for storing the time stamp values and addresses of successive cells in said each of the logical queues.

10. The apparatus as recited in claim 9, wherein, if the input cell is provided, the controlling means performs the input process of the buffering means through the steps of:
(c1) examining whether the same VCI value as that of the input cell exists in the CAM part of the memory table;
(c2) if the storage means contains no VCI value corresponding to the input cell, registering a new VCI value in the CAM part and writing a new buffer address of the input cell supplied from the idle address providing means on the RAM part of the storage means, wherein the input cell is treated as a head cell of a new logical queue corresponding to the new VCI value; and
(c3) if the CAM part of the storage means contains the same VCI value as that of the input cell, receiving the buffer address of the head cell of the logical queue corresponding to the VCI value of the input cell, reading a time stamp value of the head cell and the address of the subsequent cell from the second field by using the buffer address of the head cell, and finding the proper position of the input cell to thereby place the input cell at the proper position by comparing the time stamp value of the input cell with those of the cells stored in the buffering means.

11. The apparatus as recited in claim 10, wherein, if the storage means contains no VCI value corresponding to the input cell, the input cell and its time stamp value are transferred from the first registering means to the addressed position in the buffering means in response to said new buffer address and an end of logical queue (EOL) mark is written on the second field.

12. The apparatus as recited in claim 11, wherein the controlling means performs the output process of the buffering means through the steps of:
(d1) receiving a VCI value shifted out from the second registering means;
(d2) receiving an address of a head cell of a logical queue corresponding to said VCI value from the storage means; and
(d3) outputting said head cell pointed by the address.

13. The apparatus as recited in claim 1, wherein the predetermined cell time is V cell times, V being a difference between the minimum and the maximum permissible transfer delay within the switch fabric.

14. A method for restoring cell sequence in a switch fabric, which comprises the steps of:
(a) examining a virtual channel identifier (VCI) value of an input cell and transmitting the input cell to a logical queue that has a same VCI as that of the input cell;
(b) placing the input cell at a proper position in the logical queue by comparing a time stamp value of the input cell with those of cells stored in the logical queue;
(c) repeating the steps (a) and (b) for a plurality of input cells;
(d) selecting a head cell among the cells stored in the logical queue by using the VCI value of the input cell as an index after a predetermined cell time;
(e) outputting the head cell as an output cell; and
(f) repeating the steps (d) and (e) for the remaining cells among the input cells.

15. The method of claim 14, wherein the predetermined cell time is V cell times, V being a difference between the minimum and the maximum permissible transfer delay within the switch fabric.
